(19) United States
(12) Patent Application Publication
(10) Pub. No.: US 2025/0193979 A1
(43) Pub. Date: Jun. 12, 2025

(54) THERMAL BARRIER ASSEMBLIES WITH THERMAL RESISTANCE MATERIAL LAYERS OF A NON-UNIFORM THICKNESS

(71) Applicant: FORD GLOBAL TECHNOLOGIES, LLC, Dearborn, MI (US)

(72) Inventors: Mohammadreza Eftekhari, Novi, MI (US); Kanchana Perumalla, Troy, MI (US); Kyle Anzicek, Madison Heights, MI (US)

(21) Appl. No.: 18/780,986

(22) Filed: Jul. 23, 2024

Related U.S. Application Data
(60) Provisional application No. 63/607,888, filed on Dec. 8, 2023.

(51) Int. Cl. H05B 45/22; H01M 10/625; H01M 50/249; H01M 50/291; H01M 50/293

(52) U.S. Cl. CPC H05B 45/22; H01M 10/625; H01M 50/249; H01M 50/291; H01M 50/293

(57) ABSTRACT

Thermal barrier assemblies are provided for inhibiting the transfer of thermal energy inside a traction battery pack. An exemplary thermal barrier assembly may include a structural barrier flanked by a pair of thermal resistance material layers. The structural barrier and the thermal resistance material layers may each include a non-uniform thickness. The structural barrier may include a reduced thickness at its respective outboard edges, and the thermal resistance layers may each include an increased thickness at their respective outboard edges. Providing a greater amount of thermal resistance material near the outboard edges of battery cells can help slow or even eliminate the transfer of thermal energy across a cell stack of the traction battery pack during a thermal event.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to thermal barrier assemblies arranged for mitigating the transfer of thermal energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a thermal barrier assembly arranged to partition a battery cell stack into a first compartment and a second compartment. A structural barrier and a thermal resistance material layer of the thermal barrier assembly each include a non-uniform thickness.

In a further non-limiting embodiment of the foregoing traction battery pack, the thermal resistance material layer is sandwiched between the structural barrier and a foam layer of the thermal barrier assembly.

In a further non-limiting embodiment of either of the foregoing traction battery packs, the thermal resistance material layer includes an aerogel or a mica sheet.

In a further non-limiting embodiment of any of the foregoing traction battery packs, the thermal resistance material layer includes a first outboard edge portion, a second outboard edge portion, and a mid-portion that extends between the first outboard edge portion and the second outboard edge portion.

In a further non-limiting embodiment of any of the foregoing traction battery packs, the mid-portion includes a first thickness, and each of the first outboard edge portion and the second outboard edge portion includes a second thickness that is greater than the first thickness.

In a further non-limiting embodiment of any of the foregoing traction battery packs, the structural barrier includes a first outboard edge portion, a second outboard edge portion, and a mid-portion that extends between the first outboard edge portion and the second outboard edge portion.

In a further non-limiting embodiment of any of the foregoing traction battery packs, the mid-portion includes a first thickness, and each of the first outboard edge portion and the second outboard edge portion includes a second thickness that is less than the first thickness.

In a further non-limiting embodiment of any of the foregoing traction battery packs, the thermal barrier assembly includes a uniform overall thickness.

In a further non-limiting embodiment of any of the foregoing traction battery packs, a first outboard edge portion of the structural barrier is received in abutting contact with a first outboard edge portion of the thermal resistance material layer.

In a further non-limiting embodiment of any of the foregoing traction battery packs, the first outboard edge portion of the structural barrier includes a first thickness, and the first outboard edge portion of the thermal resistance material layer includes a second thickness that is greater than the first thickness.

In a further non-limiting embodiment of any of the foregoing traction battery packs, the structural barrier includes a pultrusion.

In a further non-limiting embodiment of any of the foregoing traction battery packs, the structural barrier includes an upper interfacing structure having a basin configured to receive an adhesive.

A traction battery pack according to another exemplary aspect of the present disclosure includes, among other things, an upper enclosure structure, a lower enclosure structure, and a cell stack arranged between the upper enclosure structure and the lower enclosure structure and including a first grouping of battery cells, a second grouping of battery cells, and a thermal barrier assembly that separates the first grouping of battery cells from the second grouping of battery cells. The thermal barrier assembly includes a structural barrier sandwiched between a first thermal resistance material layer and a second thermal resistance material layer. Each of the first thermal resistance material layer and the second thermal resistance material layer includes a non-uniform thickness.

In a further non-limiting embodiment of the foregoing traction battery pack, the first thermal resistance material layer is flanked by a first foam layer, and the second thermal resistance material layer is flanked by a second foam layer.

In a further non-limiting embodiment of either of the foregoing traction battery packs, the structural barrier includes a non-uniform thickness.

In a further non-limiting embodiment of any of the foregoing traction battery packs, the thermal barrier assembly includes a uniform overall thickness.

In a further non-limiting embodiment of any of the foregoing traction battery packs, each of the first thermal resistance material layer and the second thermal resistance material layer includes a first outboard edge portion, a second outboard edge portion, and a mid-portion that extends between the first outboard edge portion and the second outboard edge portion.

In a further non-limiting embodiment of any of the foregoing traction battery packs, the mid-portion includes a first thickness, and each of the first outboard edge portion and the second outboard edge portion includes a second thickness that is greater than the first thickness.

In a further non-limiting embodiment of any of the foregoing traction battery packs, the structural barrier includes a first outboard edge portion, a second outboard edge portion, and a mid-portion that extends between the first outboard edge portion and the second outboard edge portion.

In a further non-limiting embodiment of any of the foregoing traction battery packs, the mid-portion includes a first thickness, and each of the first outboard edge portion and the second outboard edge portion includes a second thickness that is less than the first thickness.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack of an electrified vehicle.

FIG. 3 is a cross-sectional view of select portions of a cell stack of a traction battery pack.

FIG. 4 is a top view of select portions of the cell stack of FIG. 3.

### DETAILED DESCRIPTION

This disclosure details thermal barrier assemblies configured for inhibiting the transfer of thermal energy inside a traction battery pack. An exemplary thermal barrier assembly may include a structural barrier flanked by a pair of thermal resistance material layers. The structural barrier and the thermal resistance material layers may each include a non-uniform thickness. The structural barrier may include a reduced thickness at its respective outboard edges, and the thermal resistance layers may each include an increased thickness at their respective outboard edges. Providing a greater amount of thermal resistance material near the outboard edges of battery cells can help slow or even eliminate the transfer of thermal energy across a cell stack of the traction battery pack during a thermal event. These and other features are discussed in greater detail in the following paragraphs of this detailed description.

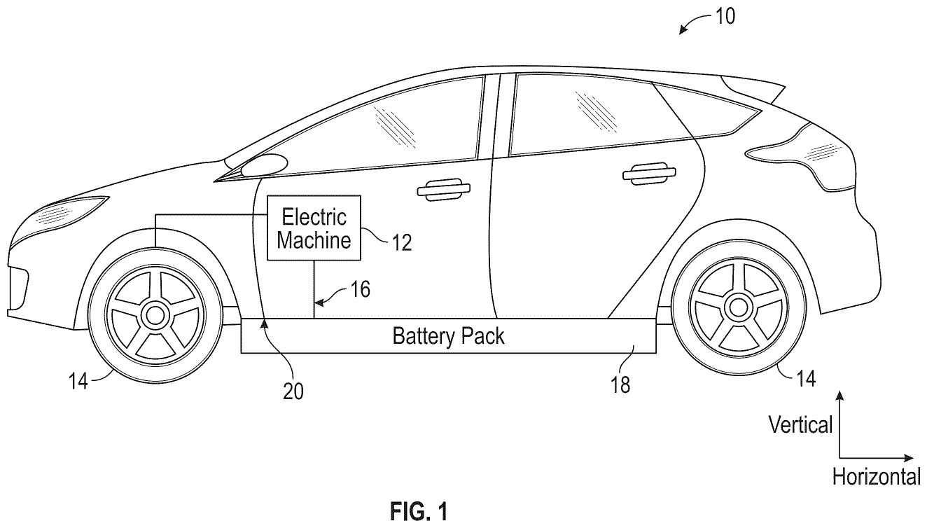

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

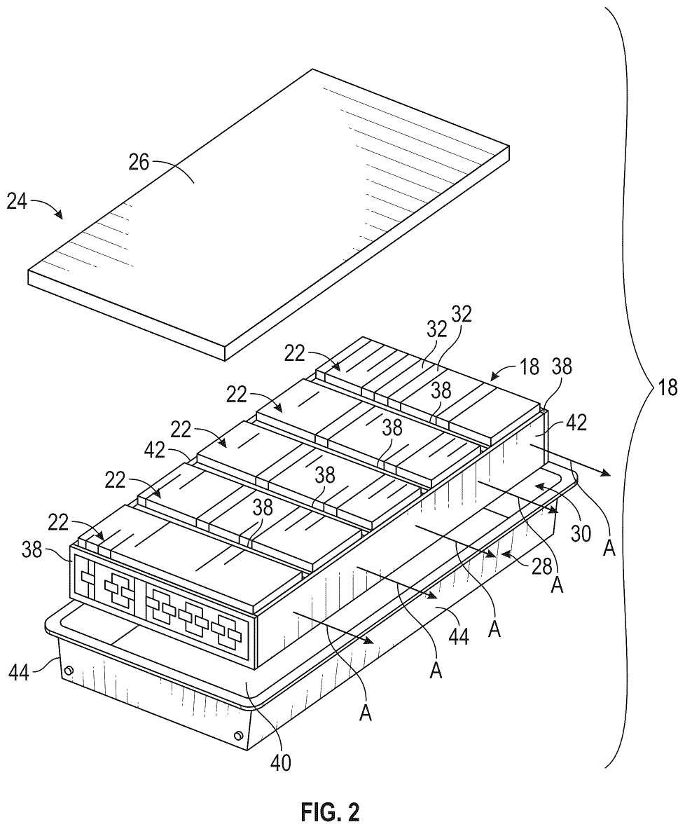

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and to the cross-member assemblies 38. In some implementations, the end plates 42 are structural members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

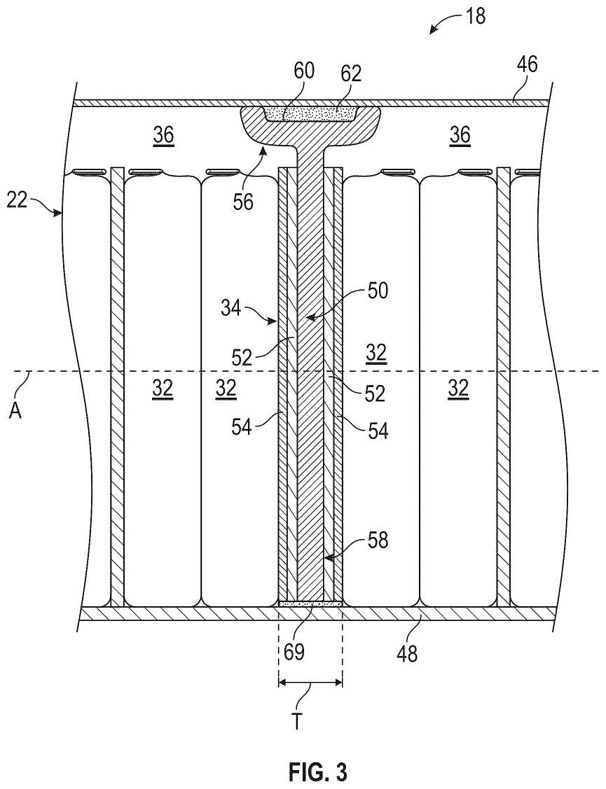

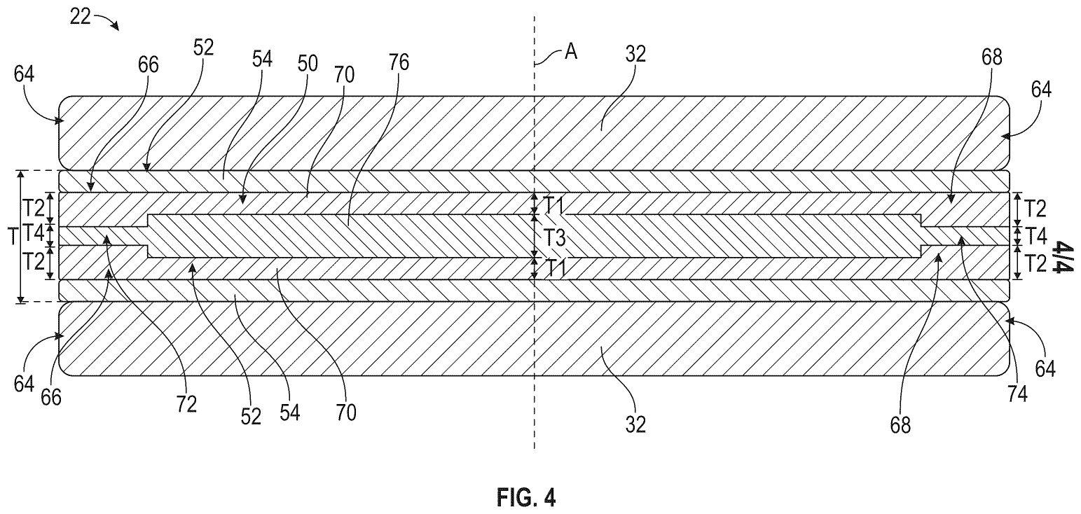

Referring now to FIGS. 3-4, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 of the cell stack 22.

Should, for example, a battery thermal event occur in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. The thermal barrier assemblies 34 may further be configured to structurally join battery enclosure structures to increase the structural integrity of the traction battery pack 18.

Each thermal barrier assembly 34 may be configured to establish a sealed interface at both an upper enclosure structure 46 and a lower enclosure structure 48 of the traction battery pack 18. The upper enclosure structure 46 may be part of the enclosure cover 26 of the enclosure assembly 24 or could be an intermediate structure (e.g., an actively cooled heat exchanger plate) that is positioned between the thermal barrier assembly 34 and the enclosure cover 26. The lower enclosure structure 48 may be part of the actively cooled heat exchanger plate 40 that is positioned between the structural thermal barrier assembly 34 and the enclosure tray 28, or could alternatively be part of the enclosure tray 28.

Each thermal barrier assembly 34 of the cell stack 22 may include a structural barrier 50 that is flanked by pairs of thermal resistance material layers 52 and foam layers 54 as part of a multi-layer sandwich structure of the thermal barrier assembly 34. In the illustrated embodiment, the structural barrier 50 may be sandwiched between the thermal resistance material layers 52, and the foam layers 54 may be positioned outboard of the foam layers 54. The foam layers 54 may thus flank the thermal resistance material layers 52 and can be positioned in abutting contact with major side surfaces of battery cells 32 located in adjacent compartments 36 of the cell stack 22.

The structural barrier 50 may include a thermoplastic structure or a polymer composite structure (e.g., glass fiber reinforced polypropylene with an intumescent additive), for example, the thermal resistance material layers 52 may include aerogel layers or mica sheets, for example, and the foam layers 54 may include polyurethane foam or silicone foam, for example. However, other materials or combinations of materials could be utilized to construct the subcomponents of the thermal barrier assembly 34 within the scope of this disclosure.

As will be appreciated by persons of ordinary skill in the art having the benefit of this disclosure, the exemplary thermal barrier assembly 34 of FIGS. 3-4 is not shown drawn to scale. A thickness T (e.g., in a direction of the cell stack axis A) of the thermal barrier assembly 34 has been exaggerated to better illustrate its substituent components and their arrangement relative to one another. In an embodiment, the thickness T may be between about 7 mm and about 20 mm, for example. However, other thicknesses are contemplated within the scope of this disclosure. In this disclosure, the term “about” means that the expressed quantities or ranges need not be exact but may be approximated and/or larger or smaller, reflecting acceptable tolerances, conversion factors, measurement error, etc.

The structural barrier 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

The structural barrier 50 of the thermal barrier assembly 34 may include an upper interfacing structure 56 that is configured to interface with the upper enclosure structure 46, and a lower interfacing structure 58 that is configured to interface with lower enclosure structure 48. Together, the upper interfacing structure 56 and the lower interfacing structure 58 may establish a T-shaped cross-section of the structural barrier 50. However, other shapes are contemplated within the scope of this disclosure.

The upper interfacing structure 56 may include a dish-like basin 60 for receiving and holding an adhesive 62 for securing the thermal barrier assembly 34 to the upper enclosure structure 46. The adhesive 62 may be an epoxy based adhesive or a urethane based adhesive, for example. Once the upper interfacing structure 56 is secured relative to the upper enclosure structure 46, the thermal barrier assembly 34 can substantially prevent thermal energy from moving from one compartment 36 to another at the sealed interface between the thermal barrier assembly 34 and the upper enclosure structure 46, such as during a battery thermal event, for example.

The lower interfacing structure 58 may be disposed on an opposite end of the structural barrier 50 from the upper interfacing structure 56. The lower interfacing structure 58 may be substantially flat or could include a notched section configured for accommodating a contour of the lower enclosure structure 48. The lower interfacing structure 58 may therefore help locate the thermal barrier assembly 34 relative to the lower enclosure structure 48 during assembly.

The lower interfacing structure 58 may be fixedly secured to the lower enclosure structure 48 to increase the overall rigidity of the traction battery pack 18. A thermal interface material 69, which could be an adhesive or an insulation material, for example, may be utilized to secure the lower interfacing structure 58 to the lower enclosure structure 48. The thermal interface material 69 could also provide sealing purposes. The thermal interface material 69 (e.g., epoxy resin, silicone based materials, thermal greases, etc.) may additionally be disposed between the battery cells 32 of the cell stack 22 and the lower enclosure structure 48 for facilitating heat transfer therebetween.

Once the upper interfacing structure 56 is joined to the upper enclosure structure 46 and the lower interfacing structure 58 is joined to the lower enclosure structure 48, the upper and lower enclosure structures 46, 48 are effectively structurally coupled to one another. The thermal barrier assemblies 34 are therefore configured for increasing the structural stiffness of the traction battery pack 18.

The battery cells 32 of the cell stacks 22 may not heat up uniformly during operation of the traction battery pack 18. For example, opposing outboard edges of each battery cell 32 near where the tab terminals project outwardly from the battery cell housing may experience temperature increases at a faster rate than the mid-body section of the battery cell housing during certain conditions, such as battery thermal events in which one or more of the battery cells 32 discharge battery vent byproducts, for example. The thermal barrier assemblies 34 can be designed to compensate for the non-uniform heating of the battery cells 32.

For example, as best illustrated in FIG. 4, select portions of each thermal resistance material layer 52 of the thermal barrier assembly 34 that are located near outboard edges 64 of the battery cells 32 may be thickened in order to reduce or event prevent the transfer of thermal energy originating from these hot spots of the battery cells 32 during a battery thermal event. Further, select portions of the structural barrier 50 may be thinned to maintain a uniform overall thickness T of the thermal barrier assembly 34. The thermal resistance material layers 52 and the structural barrier 50 may thus both exhibit a non-uniform thickness.

Each thermal resistance material layer 52 may include a first outboard edge portion 66, a second outboard edge portion 68, and a mid-portion 70 that extends between the first outboard edge portion 66 and the second outboard edge portion 68. The mid-portion 70 may include a thickness T1, and each of the first outboard edge portion 66 and the second outboard edge portion 68 may include a thickness T2 that is greater than the thickness T1. The thermal resistance material layers 52 are therefore each “thickened” at the first outboard edge portion 66 and the second outboard edge portion 68. The first outboard edge portions 66 and the second outboard edge portions 68 are located closer to the outboard edges 64 of the battery cells 32 compared to the non-thickened sections of the thermal resistance material layers 52 and can thus provide increased thermal resistance at known hot spots of the battery cells 32 both prior to and during battery thermal events.

The structural barrier 50 may likewise include a first outboard edge portion 72, a second outboard edge portion 74, and a mid-portion 76 that extends between the first outboard edge portion 72 and the second outboard edge portion 74. The first outboard edge portion 72 may be sandwiched between the first outboard edge portions 66 of the pair of thermal resistance material layers 52 and is thus in abutting contact with each first outboard edge portion 66, and the second outboard edge portion 74 may be sandwiched between the second outboard edge portions 68 of the pair of thermal resistance material layers 52 and is thus in abutting contact with each second outboard edge portion 68. The mid-portion 76 of the structural barrier 50 may be sandwiched between the mid-portions 70 of the pair of thermal resistance material layers 52.

The mid-portion 76 of the structural barrier 50 may include a thickness T3, and each of the first outboard edge portion 72 and the second outboard edge portion 74 may include a thickness T4 that is less than the first thickness T3. The structural barrier 50 is therefore “thinned” at the first outboard edge portion 72 and the second outboard edge portion 74 in order to accommodate the thickened outboard edges 66, 68 of the thermal resistance material layers 52 and thereby maintain the uniform overall thickness T of the thermal barrier assembly 34.

In an embodiment, the thickness T1 of the mid-portion 70 of each thermal resistance material layer 52 is about 1 mm, the thickness T2 of each outboard edge portion 66, 68 of the thermal resistance material layers 52 is about 2 mm, the thickness T3 of the mid-portion 76 of the structural barrier 50 is about 3 mm, and the thickness T4 at each outboard edge portion 72,74 of the structural barrier 50 is about 1 mm. However, other thicknesses are contemplated within the scope of this disclosure.

The thermal barrier assemblies of this disclosure provide for blocking gases and protecting surrounding structures while maintaining structure, sealing, and thermal resistance in a relatively thin profile compared to prior thermal barriers. The exemplary thermal barrier assemblies may include a structural barrier and thermal resistance material layers that have non-uniform thicknesses in order to provide a greater amount of thermal resistance material near battery cell areas that will rise to the highest temperatures during battery thermal events. The exemplary thermal barrier assemblies are therefore uniquely equipped to slow or even prevent the cell-to-cell transfer of thermal energy.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a thermal barrier assembly arranged to partition a battery cell stack into a first compartment and a second compartment; and
a structural barrier and a thermal resistance material layer of the thermal barrier assembly each including a non-uniform thickness.

2. The traction battery pack as recited in claim 1, wherein the thermal resistance material layer is sandwiched between the structural barrier and a foam layer of the thermal barrier assembly.

3. The traction battery pack as recited in claim 1, wherein the thermal resistance material layer includes an aerogel or a mica sheet.

4. The traction battery pack as recited in claim 1, wherein the thermal resistance material layer includes a first outboard edge portion, a second outboard edge portion, and a mid-portion that extends between the first outboard edge portion and the second outboard edge portion.

5. The traction battery pack as recited in claim 4, wherein the mid-portion includes a first thickness, and each of the first outboard edge portion and the second outboard edge portion includes a second thickness that is greater than the first thickness.

6. The traction battery pack as recited in claim 1, wherein the structural barrier includes a first outboard edge portion, a second outboard edge portion, and a mid-portion that extends between the first outboard edge portion and the second outboard edge portion.

7. The traction battery pack as recited in claim 6, wherein the mid-portion includes a first thickness, and each of the first outboard edge portion and the second outboard edge portion includes a second thickness that is less than the first thickness.

8. The traction battery pack as recited in claim 1, wherein the thermal barrier assembly includes a uniform overall thickness.

9. The traction battery pack as recited in claim 1, wherein a first outboard edge portion of the structural barrier is received in abutting contact with a first outboard edge portion of the thermal resistance material layer.

10. The traction battery pack as recited in claim 1, wherein the first outboard edge portion of the structural barrier includes a first thickness, and the first outboard edge portion of the thermal resistance material layer includes a second thickness that is greater than the first thickness.

11. The traction battery pack as recited in claim 1, wherein the structural barrier includes a pultrusion.

12. The traction battery pack as recited in claim 11, wherein the structural barrier includes an upper interfacing structure having a basin configured to receive an adhesive.

13. A traction battery pack, comprising:
an upper enclosure structure;
a lower enclosure structure; and
a cell stack arranged between the upper enclosure structure and the lower enclosure structure and including a first grouping of battery cells, a second grouping of battery cells, and a thermal barrier assembly that separates the first grouping of battery cells from the second grouping of battery cells,
wherein the thermal barrier assembly includes a structural barrier sandwiched between a first thermal resistance material layer and a second thermal resistance material layer, and further wherein each of the first thermal resistance material layer and the second thermal resistance material layer includes a non-uniform thickness.

14. The traction battery pack as recited in claim 13, wherein the first thermal resistance material layer is flanked by a first foam layer, and the second thermal resistance material layer is flanked by a second foam layer.

15. The traction battery pack as recited in claim 13, wherein the structural barrier includes a non-uniform thickness.

16. The traction battery pack as recited in claim 13, wherein the thermal barrier assembly includes a uniform overall thickness.

17. The traction battery pack as recited in claim 13, wherein each of the first thermal resistance material layer and the second thermal resistance material layer includes a first outboard edge portion, a second outboard edge portion, and a mid-portion that extends between the first outboard edge portion and the second outboard edge portion.

18. The traction battery pack as recited in claim 17, wherein the mid-portion includes a first thickness, and each of the first outboard edge portion and the second outboard edge portion includes a second thickness that is greater than the first thickness.

19. The traction battery pack as recited in claim 13, wherein the structural barrier includes a first outboard edge portion, a second outboard edge portion, and a mid-portion that extends between the first outboard edge portion and the second outboard edge portion.

20. The traction battery pack as recited in claim 19, wherein the mid-portion includes a first thickness, and each of the first outboard edge portion and the second outboard edge portion includes a second thickness that is less than the first thickness.
